(19) United States
(12) Patent Application Publication
(10) Pub. No.: US 2017/0234059 A1
(43) Pub. Date: Aug. 17, 2017

(54) PLUG SYSTEM

(71) Applicant: Philippe CHANCEREL, Glos-la-Ferriere (FR)

(72) Inventor: Philippe CHANCEREL, Glos-la-Ferriere (FR)

(21) Appl. No.: 15/329,593

(22) PCT Filed: Mar. 20, 2015
(86) PCT No.: PCT/EP2015/055938

§ 371 Date: Jan. 27, 2017

(30) Foreign Application Priority Data
Mar. 21, 2014 (FR) FR 1452399
Mar. 21, 2014 (FR) FR 1452400
Mar. 21, 2014 (FR) FR 1452401

(51) Int. Cl. E06B 3/96; E06B 5/02; E06B 9/24; E06B 3/30; E06B 1/36; E06B 1/52; E06B 1/64; E06B 7/22; E06B 1/34

(52) U.S. Cl. CPC E06B 3/9632; E06B 7/22; E06B 3/962; E06B 5/025; E06B 9/24; E06B 1/34; E06B 1/36; E06B 1/52; E06B 1/64; E06B 3/30

(57) ABSTRACT

System for plugging an opening, including:
a plug element designed to cover said opening,
a frame made up of at least four rails (1′) designed to be positioned inside the opening and including a first groove (22) formed on a front wall of each rail, and
a seal (29),
   said first groove (22) being designed to accommodate a substantially peripheral part (27) of the plug element, said seal (29) being designed to be accommodated with a tight fit in retaining means (34) inserted in said groove (22) and retaining said plug element on the frame.

The present invention relates to a system for plugging an opening, of the door or window opening type delimited by a door frame or window frame or of a type delimited by adjacent walls, including:
a plug element, for example a tarpaulin, designed to cover said opening,
a frame, made up of at least four structural sections each forming a rail of said frame, each structural section comprising a front wall, a dorsal wall and two connecting walls and having an opening part forming a cavity of a substantially U-shaped groove, said frame being designed to be positioned inside said opening and having first fixing means, and
second fixing means,
   said first and second fixing means being designed to co-operate with one another to retain said plug element on said frame and to be separable so as to allow the withdrawal of said plug element on the frame, said first fixing means being an opening defined by a longitudinal orifice present on said front wall of each structural section forming an opening of said groove, the adjacent parts of said opening being formed by two internal lips each extending from one of the connecting walls, said groove of said structural section being designed to accommodate a substantially peripheral part of the plug element passing through said opening, said second fixing means being formed of at least one peripheral seal designed to be held with a tight fit by each internal lip of said opening of said groove in which said substantially peripheral part of said plug means is accommodated and fixed.

In this context, said plug element is fixed to the frame by placing a seal on the substantially peripheral part of said plug element accommodated in said opening forming a cavity of a groove of each structural section forming a rail of said frame, so as to form a seal/plug element pair, accommodated in said groove, which forms a joint deemed hermetically sealed between the frame and the plug element.

A system as described above, known from the document FR2961549, is used for example as a system for plugging an opening of the door opening or window opening type. It is then used in the context of works, for example refurbishing a room in a building, known to be a source of sometimes extremely volatile dust that may invade and/or be spread into the other rooms of a building directly connected to the room where work is being carried out. This is in no way desirable, especially in that the dust in question can sometimes have pollutant or toxic properties, and therefore hazardous properties, because of its particle size and/or its physical/chemical nature.

For example, in the case of removing asbestos from a building, asbestos dust or fine asbestos residues are generated that must not in any circumstances be released into the environment outside the room where work is being carried out.

Unfortunately, a system of this kind has a major drawback: the separation of the plug element from the frame when the system is subjected to stimuli or stresses, which can arise at any time when on a site adjacent other rooms may be open to an exterior environment and be the location of much coming and going inherent to the activity taking place therein. The same thing can occur for example if a tool is dropped onto the plug element or if the latter is struck, for example by a ladder that is being carried. The impact and the pressure exerted on the plug element can cause the latter to be detached from the frame. In fact, following the tensions generated by these stimuli, the force joining the seal/plug element pair is not always sufficient to withstand the tension forces to which the plug element is subjected.

Also, it is found that the above system cannot be applied to all types of plug element and seal. In fact, if the plug element is rigid, for example, its retention in the groove when placing the seal becomes a tiresome task in that, because of its stiffness, the plug element does not perfectly espouse the profile of the cavity of the groove defined by the opening of each structural section forming a rail of said frame and above all tends to return to its original extended shape/position. Consequently, there is also a non-negligible risk of the seal unintentionally and unpredictably escaping from the groove in which it is accommodated, with the result that the plug system is no longer sealed.

In another situation, if the plug element and the seal are both made from a material with a low coefficient of elasticity, placing the seal in the groove containing the plug element is just as tiresome in that the seal and the plug element, when placed with a tight fit in the groove, tend to return to their original shape/position, because of their low elasticity, and therefore to escape from the groove.

Similarly, if the plug element and the seal have close or similar coefficients of friction, when placed in a tight fit in the groove the plug element and the seal tend to slide one on the other and to escape from the groove, no longer retaining the plug element on the frame.

An object of the invention is to alleviate the drawbacks of the prior art by providing a system making it possible to guarantee the hermetic sealing of the seal-plug element pair and therefore the stability of the plug system under all circumstances, and in particular if the plug element is subjected to stimuli generating tensions such that the hermetic seal of the seal-plug element pair is compromised. Moreover, the system according to the invention has the object of facilitating use and installation compared to the system described in the document FR2961549.

Another object of the invention is to provide a plug system that can be demounted and reused without the elements constituting it being damaged from one use to the other, with the aim of being able to use them again from one installation of a plug system to another.

By “hermetic seal of the seal-plug element pair” is to be understood, in the context of the present invention, a hermetically sealed seal-plug element pair, i.e. one forming a perfectly sealed closed joint. By “sealed joint” is to be understood, in the context of the invention, a joint through which no particles can pass.

To solve this problem, the invention provides a system as described at the beginning of the description characterized in that it includes means for retaining said plugging means having a first predetermined profile complementary to a second predetermined profile, said retaining means being designed to be at least partly accommodated in said groove of said structural section, between said substantially peripheral part of the plug element and said seal, superposed on top of said substantially peripheral part of said plug element so as to retain it on said frame and so as to receive said at least one peripheral seal having a third predetermined profile designed to co-operate with said first predetermined profile of said retaining means.

By “retaining means” is to be understood, in the context of the present invention, means for temporarily retaining a plug element, i.e. removable and reusable retaining means that make it possible to retain a plug element during use of the plug system, which retaining means can be removed afterwards without being damaged when demounting the plug system.

Also, according to the invention, the retaining means are designed so that they can be removed from the groove of a structural section at the same time as the seal. This is advantageous since, when a series of retaining means are used, it facilitates removing them: the retaining means remain “attached” to the seal and are not scattered around on dropping to the ground when demounting the plug system. In other words, the retaining means can be extracted when the seal is removed.

It is important to note that the retaining means according to the invention therefore do not constitute locking means such as those described for example in the document JP2010031545. That prior art document in fact describes locking means for permanently retaining a plug element on a frame.

The above prior art document more particularly describes locking means comprising a U-shaped first elastic element pushing the plug element into a groove of a structural section and a T-shaped second element that engages in the U-shaped element so as to spread (deform) the lateral parts so that it is permanently immobilized in a groove of a structural section. Also, the U-shaped element includes two lateral internal cavities designed to receive two lugs present on the external face of the T-shaped element so the latter is permanently fastened to the U-shaped element. Finally, the U-shaped element includes two lateral projections that immobilize it in the groove of the structural section, these two projections coming to abut against the lips of the groove when the U-shaped element is drawn upwards (for example when it is attempted to extract the plug element from the grove of the structural section).

Consequently, the locking element described in the document JP2010031545 is designed for permanent retention of the plug element, which cannot be detached from the groove of a structural section except by destroying the locking element. In fact, the lugs of the T-shaped element engaged in the cavities of the U-shaped element are not designed to be removed therefrom and the lateral projections of the U-shaped element the lateral walls of which are spread apart must be broken so they no longer come to abut against the lips of the groove.

According to the invention, when the plug system is being installed and the frame is placed in an opening, it is necessary to position the plug element. According to one embodiment, this means that the installer must hold the plug element, align it along a structural section forming a base rail of the frame and insert the base part of said plug element in the opening of the substantially peripheral base structural section forming a groove. The retaining means that will retain at least a substantially peripheral part of the plug element in the groove while the peripheral seal is placed therein are then placed in this groove. Thereafter, the installer straightens the plug element into a vertical position and then positions a series of retaining means in the structural sections forming the lateral-vertical rails of the frame over the plug element when straightened in the plugging position to cover the opening. Finally, they easily place the retaining means on top of at least an upper peripheral part of the plug element when the lower part of the latter is firmly anchored in said groove just like at least one lateral peripheral part. They can then take the time to position the longitudinal seals comfortably and easily in the lateral and upper grooves and therefore to establish the total hermetic seal of the system. Of course, in the context of the present invention, the retaining means can have a length much less than the width of the opening. In this case, the installer can fir a plurality of retaining means at regular intervals. On the other hand, if the retaining element is of great length, the installer can fit many fewer of them.

According to another embodiment, the plug element may be installed on the frame by aligning it with the structural section forming the upper rail of the frame and placing at least a substantially peripheral upper part of the plug element in the cavity of the groove defined by an opening part of the structural section forming the upper rail. It is then necessary to install retaining means that will retain the substantially peripheral part of the plug element in the opening of a structural section forming a groove, said structural section forming an upper rail of said frame for the time required to place a peripheral seal therein. The installer can then allow the plug element deploy from top to bottom under its own weight without its substantially peripheral upper part becoming detached. The plug element is in fact firmly connected to the upper rail of the frame by virtue of the presence of the retaining means retaining the substantially peripheral upper part of the plug element in the groove of the structural section forming the upper rail. The installer will then fit a series of retaining means in the structural sections forming the lateral-vertical rails of the frame from above the plug element erected into the plugging position to cover the opening. Finally, they will easily fit the retaining means over at least a substantially peripheral base part of the plug element without any difficulty if the upper part and the peripheral lateral parts of the plug element are firmly anchored in the groove. The operative can then take their time to fit the longitudinal seals comfortably and easily in the lateral and base grooves and therefore ensure that the system is totally hermetically sealed.

Also, the presence of retaining means positioned between the plug element and the seal but with everything accommodated in the groove makes it possible to reduce drastically the impact of the coefficients of friction of the seals and the plug element, which may then take any value, leaving a free choice as to the nature of the materials forming said peripheral seal and the plug element.

Similarly, when the materials are somewhat elastic or rigid, the impact on the assembly will also be greatly reduced.

Also, said plug element possibly includes a zip fastener. The presence of this zip fastener then makes it possible to facilitate movement to a site by allowing temporarily opening of the plugging system without having systematically to demount it from and remount it on the frame.

Said at least one peripheral seal is preferably made of a flexible material.

Said at least one peripheral seal advantageously includes a plurality of longitudinal seals.

Said retaining means are preferably made from a rigid material.

Said retaining means advantageously include a plurality of retaining means.

At least one of said rails of the frame preferably includes a first, external structural section and a second, internal structural section designed to co-operate by sliding to form a telescopic rail including:
a first, external structural section comprising a front wall, a dorsal wall and two connecting walls, each of the walls having an internal face and an external face, said first structural section including an opening part forming a cavity of a first substantially U-shaped groove, said front wall including a longitudinal orifice forming an opening of said first groove the adjacent parts of which are formed by two internal lips each extending from one of the connecting walls, and
a second, internal structural section comprising a front wall, a dorsal wall and two connecting walls, each of the walls having an internal face and an external face, said external face of one of said connecting walls of said second structural section including a brush over at least part of its length, said structural section including an opening part forming a cavity of a second substantially U-shaped groove, said front wall including a longitudinal orifice forming an opening of said second groove the adjacent parts of which are formed by two internal lips each extending from one of the connecting walls,
   said second groove of said second, internal structural section and said first groove of said first, external structural section forming, when said first ember and second structural sections are designed to co-operate by sliding, a groove resulting from at least partial superposition of two structural sections including a longitudinal orifice formed by the at least partial alignment of said longitudinal orifice present on the front wall of said first structural section and said longitudinal orifice present on the front wall of said second structural section, said groove resulting from at least partial superposition of two structural sections being designed to receive and to retain at least partly a substantially peripheral part of said plug element.

By “cooperating by sliding” is to be understood, in the context of the present invention, the at least partial overlapping of one element by another or at least partial insertion of one element concentrically relative to another. Here, in the present instance, the second substantially U-shaped groove of the internal structural section slides at least partly in the substantially U-shaped first grove of the external structural section and is therefore at least partly covered by the latter. In this context, the sliding of the internal structural section in the external structural section of each telescopic rail causes the aforementioned two grooves to coincide so as to form a single substantially U-shaped groove. In this way, because of the presence of telescopic rails, the frame is adaptable to a wide range of dimensions of said opening to be plugged, which does not in any situation call into question the hermetic seal of the plugging of the opening thanks to the peripheral seal/plug element pair and the advantageous presence of retaining means.

In one particular embodiment, two adjacent rails of the frame are nested in a preferably solid joining piece so that the rails are not parallel, in particular substantially perpendicular.

Said joining piece preferably has a first end including means for mutual coupling with an end of said external structural section of a first telescopic rail and a second end including means for mutual coupling with an end of said internal structural section of an adjacent second telescopic rail, said joining piece having at said first end a groove designed to co-operate with said groove of said external structural section of said first rail and having at said second end a groove designed to co-operate with said groove of said internal structural section of said second rail.

The presence of the joining piece makes it possible to orient the positioning of the rails of the frame against each side of the opening, as described above and in particular in the context of an opening defined by a door frame or a window frame. The joining piece allows the rails of the frame to espouse perfectly the profile of the opening since each joining piece is designed so that, when installing the frame, it comes to abut against the corners of said opening, which makes it possible to enhance the seal of the plug system.

Alternatively, said joining piece includes a groove on a front face designed to connect said groove of said first end and said groove of said second end of the joining piece and thus to form a single continuous groove.

In this way, the substantially peripheral part of the plug element can be fixed to the joining piece so that the hermetic seal of the seal-plug element pair is guaranteed as much at the level of the joining piece as at the level of each rail forming the frame.

In one particularly advantageous embodiment of the plug system according to the invention, retaining means include a back wall and two facing lateral walls, said lateral walls extending from said back wall and having on the one hand an external face designed to face an internal face of said substantially U-shaped groove of a structural section forming a rail of said frame and on the other hand an internal face opposite the external face of the same lateral wall and oriented toward the interior of the retaining means.

According to another embodiment, the external face of each lateral wall of said retaining means is designed to face an internal face of a groove formed when said first and second structural sections of a telescopic rail are designed to co-operate by sliding, each of the structural sections including an opening part forming a cavity of a substantially U-shaped groove.

Also, according to the invention, each external face of said retaining element includes at least one protuberance designed to force nesting of said retaining piece in said cavity of said groove formed in an opening of a structural section forming a rail of said frame or formed if said first and second structural sections of a telescopic rail are designed to co-operate by sliding and form a groove defined by the sliding of said second groove in said first groove.

The presence of at least one protuberance oriented toward an internal face of said groove on the lateral walls of the retaining means makes it possible to accentuate locally the force of cohesion and of pressure generated on the walls of said groove. In fact, the protuberance or protuberances exert(s) a localized pressure on the plug element and the internal face of the groove when a substantially peripheral part of said plug element is placed in said groove.

Each internal face of each lateral wall of said retaining means optionally includes at least one protuberance oriented in a direction opposite that of the projection on the external face. Also, said seal also has a longitudinal projection having a first predetermined thickness e1 and terminated by first and second shoulders having a predetermined height h1 to form an assembly having a second predetermined thickness e2, said lateral walls of the retaining means being separated from one another by a predetermined distance d1 such that d1≦e2, each shoulder of said seal being designed to be placed between the back wall of the retaining means and each protuberance present on the internal faces of the lateral walls of the retaining means.

The projection of each internal face of the retaining means advantageously has a third predetermined thickness e3 and is placed at a second predetermined distance d2 from the back wall of the retaining means such that e3≧e2−e1 and/or h1≧d2.

In this way, once accommodated with a tight fit in the retaining means, by virtue of the presence of the projections on the internal faces of the retaining means, the seal is firmly attached to the latter. In this way, when replacing the plug element, the removal of the seal from a groove formed of a structural section forming a rail of the frame or from a groove formed by the sliding of a groove of the second, internal structural section in a groove of the first, external structural section of a telescopic rail is effected conjointly with the removal of said retaining means. This makes it possible to withdraw the plug element more quickly from its location, for example if the latter is damaged. It then suffices for the person skilled in the art easily to separate the retaining means and the seal, to fit a new plug element, retaining means and a seal to form a new plug system.

Said longitudinal projection of the seal optionally has an arrowhead-shaped cross section terminating at a distal end, said arrowhead being designed to be oriented toward the retaining means, each of the first and second shoulders of the longitudinal projection being designed to be in contact with each internal face of the retaining means when said seal is mounted with a tight fit in the retaining means.

The frame designed to be positioned in an opening is preferably a telescopic system designed to receive a plug element, for example a tarpaulin, and including at least four joining pieces, in particular four corner pieces, in which two perpendicular adjacent rails are nested.

Two adjacent perpendicular rails nested in said joining piece, in particular in a corner piece, are advantageously connected by compensation means, for example by a flat spring.

By “nested” is to be understood, in the context of the invention, that one element is at least partly covered and retained by another element or by at least partial insertion of one element concentrically with respect to another element. Here, for example, each rail is substantially nested in a part of the joining piece so that the rails are not parallel, in particular substantially perpendicular.

Other embodiments of the plug system according to the invention are indicated in the appended claims.

The present invention also relates to a method of plugging an opening, of the door opening or window opening type delimited by a door frame or window frame or of a type delimited by adjacent walls, including the following steps:
joining at least four structural sections two by two by means of a joining piece to form a frame, each structural section forming a rail of said frame, said joining piece having a first end designed to be connected to a first rail and a second end designed to be connected to a second rail adjacent said first rail,
placing the frame inside the opening so that it bears against each side of said opening,
inserting at least one substantially peripheral part of a plug element in a groove present in each structural section or in a groove formed by the sliding of a second groove of a second, internal structural section in a first groove of a first, external structural section of a telescopic rail if said first and second structural sections are designed to co-operate by sliding, and
positioning at least one seal in said groove present on each structural section with a tight fit so as to fix thereto said at least one substantially peripheral part of the plug element so as to form a system for plugging said opening,
   characterized in that it includes a step before that of positioning said at least one seal in which retaining means, having a first predetermined profile complementary to a second profile formed by said groove and internal lips defining its opening, are placed in said groove between said substantially peripheral part of a plug element and said seal, superposed on top of said at least one substantially peripheral part of a plug element so as to retain it on said frame and so as to receive said seal having a third predetermined profile designed to co-operate with said first predetermined profile of said retaining means.

The plugging method according to the invention advantageously includes before said step of joining at least four structural sections two by two to form the frame, a step of telescopic deployment of two structural sections designed to co-operate by sliding and forming a rail of said frame so that at least one joining piece comes to abut against one of the corners of the opening. For example, each rail is a telescopic rail including a first, external structural section and a second, internal structural section, said first and second structural sections being designed to co-operate by sliding.

Said step of telescopic deployment of each rail of said frame is optionally followed by a plugging step in which said first, external structural section is fixed temporarily in a predetermined position relative to said second, internal structural section.

Said plugging step is optionally followed by a step in which two adjacent rails of said frame are connected to one another by additional compensation means designed to exert a thrust on each rail so that they bear against the sides of the opening.

Said step of positioning at least one seal in said groove of each structural section is preferably effected both in said groove of a rail of said frame and in a groove present at said first end of said joining piece, said groove of said first end of said joining piece preferably being designed to receive retaining means. In this way at least a substantially peripheral part of the plug element is connected to said joining piece.

Alternatively, said step of positioning at least one seal in said groove of each structural section forming a rail of the frame is effected both in said groove of a structural section forming a rail of said frame and in a longitudinal groove present at said second end of said joining piece, said groove of said second end of said joining piece being also designed to receive retaining means.

The plugging method optionally further includes a step of inserting a front seal with a tight fit in a front groove disposed on a front flap of at least one joining piece on top of a part of said plug element.

Alternatively, the method of plugging an opening, of the door opening or window opening type delimited by a door frame or window frame or of a type delimited by adjacent walls, may also include the following steps:
joining at least four structural sections two by two by means of a joining piece to form a frame, each structural section forming a rail, said joining piece having a first end designed to be connected to a first rail and a second end designed to be connected to a second rail adjacent said first rail,
placing the frame inside the opening so that it bears against each side of said opening,
inserting at least one substantially peripheral part of a plug element in a groove present in each structural section or in a groove formed by the sliding of a second groove of a second, internal structural section in a first groove of a first, external structural section of a telescopic rail if said first and second structural sections are designed to co-operate by sliding, and
positioning at least one seal in said groove present on each structural section with a tight fit so as to fix thereto said at least one substantially peripheral part of the plug element so as to form a system for plugging said opening,
   characterized in that said step of positioning at least one seal in said groove of each structural section forming a rail is effected both in said groove of a rail of said frame and in a longitudinal groove present at said first end of said joining piece, said groove of said first end of said joining piece being preferably designed to receive retaining means. In this way at least a substantially peripheral part of the plug element is connected to said joining piece.

Said step or positioning at least one seal in said groove of each structural section forming a rail is preferably effected both in said groove of a structural section forming a rail of said frame and in a longitudinal groove present at said first end of said joining piece, said groove of said second end of said joining piece also being designed to receive retaining means.

The method advantageously includes a step before that of positioning said at least one seal in which retaining means having a first predetermined profile complementary second profile formed by said groove and internal lips defining its opening is placed in said groove between said substantially peripheral part of a plug element and said seal, superposed on top of said at least one substantially peripheral part of a plug element so as to retain it on said frame and so as to receive said seal having a third predetermined profile designed to co-operate with said first predetermined profile of said retaining means.

Alternatively, the method includes, before said step of joining at least four structural sections two by two to form the frame, a step of telescopic deployment of two structural sections designed to co-operate by sliding and forming a telescopic rail of said frame so that at least one joining piece comes to abut against one of the corners of the opening, each rail being a telescopic rail including a first, external structural section and a second, internal structural section, said first and second structural sections being designed to co-operate by sliding.

Said step of telescopic deployment of each rail of said frame is optionally followed by a plugging step in which said first, external structural section is fixed temporarily in a predetermined position relative to said second, internal structural section.

Also, said plugging step is preferably followed by a step in which two adjacent rails of said frame are connected to one another by additional compensation means designed to exert a thrust on each rail so that they bear against the sides of the opening.

Said step or positioning at least one seal in said groove of each structural section forming a rail is advantageously effected both in said groove of a rail of said frame and in a longitudinal groove present at said first end of said joining piece, said groove of said first end of said joining piece preferably being designed to receive retaining means. In this way at least a substantially peripheral part of the plug element is connected to said joining piece.

The plugging method optionally further includes a step of inserting a front seal with a tight fit in a front groove disposed on a front flap of at least one joining piece on top of a part of said plug element.

By way of illustration, the frame may be an assembly comprising four L-shaped joining pieces and four rails, each joining piece connecting the rails of the frame two by two to form a quadrilateral designed to receive a plug element.

In one embodiment, the frame may be an assembly of six rails and six joining pieces, four of which are L-shaped, in which two opposite sides of the frame are each formed by two rails interconnected by a linear joining piece so that the two rails forming the same side are aligned with one another to form a rectangular frame of larger size.

In another embodiment, the rails of each pair of rails forming the opposite sides of the frame are interconnected by a T-shaped joining piece. An additional seventh rail is then installed to join each of the facing free ends of the T-shaped joining pieces so as to divide the frame into two frames. The opening is plugged by placing each of two plug elements on a frame constituting the assembly comprising seven rails.

Other embodiments of the method according to the invention are indicated in the appended claims.

At least one rail of the frame is preferably a telescopic rail designed to be installed in an opening in order to form a rail of a frame designed to receive a plug element, for example a tarpaulin, said telescopic rail including:
a first, external structural section comprising a front wall, a dorsal wall and two connecting walls, each of the walls having an internal face and an external face, said first structural section including an opening part forming a cavity of a first substantially U-shaped groove, said front wall including a longitudinal orifice forming an opening of said first groove the adjacent parts of which are formed by two internal lips each extending from one of the connecting walls, and
a second, internal structural section comprising a front wall, a dorsal wall and two connecting walls, each of the walls having an internal face and an external face, said external face of one of said connecting walls of said second structural section including a brush over at least part of its length, said second structural section including an opening part forming a cavity of a second substantially U-shaped groove, said front wall including a longitudinal orifice forming an opening of said second groove the adjacent parts of which are formed by two internal lips each extending from one of the connecting walls,
   said first and second structural sections being concentric and designed to co-operate by sliding.

Also, said first, external structural section includes on said internal face of a wall facing one of said connecting walls of said internal structural section a channel formed in a wall thickness and designed to receive said brush situated on said second, internal structural section when said first and second structural sections are designed to co-operate by sliding.

The presence of a channel of this kind is particularly advantageous since it makes it possible for the brush to be accommodated at least partly therein so that it no longer constitutes a thickness responsible for a considerable gap between the two structural sections. Moreover, this channel forms a guide element when the second, internal structural section slides in the first, external structural section, which also contributes to minimizing the gap between the structural sections and also to maintaining them on the same axis in order to prevent any appearance of additional rubbing and/or friction forces causing jamming as described above.

Moreover, since the brush is at least partly accommodated in this channel, the second structural section can bear against said first structural section in a narrow contact area along two lateral parts of the internal face of the first structural section, these two lateral parts being situated on either side of the channel. A narrow contact area of this kind between the two structural sections on either side of the channel constituting a guide element makes it possible to maintain permanently, i.e. even during sliding of the structural sections relative to one another, a common axis for the two structural sections which then are no longer positioned crosswise relative to one another and consequently no longer become jammed.

According to the invention, said first, external structural section of the telescopic rail advantageously further includes a U-shaped third groove including two shoulders formed in lateral walls of said third groove toward the opening of said third groove and forming two longitudinal rails the openings of which communicate with another opening part of said first, external structural section, said third groove being situated on a connecting wall opposite that including said channel and being designed to receive immobilizing means.

Said immobilizing means advantageously comprise a nut and bolt system.

According to the invention, said second, internal structural section preferably includes two lips designed to bear in the respective longitudinal rails formed by said shoulders of said U-shaped third groove present on said first, external structural section when said first and second structural sections are designed to co-operate by sliding.

The U-shaped groove therefore includes two shoulders that form two longitudinal rails and allow two lips of the second structural section to bear thereon by virtue of being inserted in said rails formed by those shoulders. Apart from the fact that this position makes it possible to orient the two structural sections correctly relative to one another, it also makes it possible to lock the telescopic rail in a given position using nut and bolt locking means. In fact, the nut and bolt system makes it possible, by a clamping effect, to compress the lips of the second structural section in the longitudinal rails formed by the shoulders so that the two structural sections are temporarily fastened to one another in a predetermined position. To be more specific, a nut is inserted in the U-shaped third groove and a bolt is engaged in that nut. When that bolt is tightened, the nut is caused to abut against the two shoulders forming the two longitudinal rails so that pressure is exerted on the lips on the second structural section that are situated in the longitudinal rails formed by the shoulders.

According to the invention, said first, external structural section advantageously includes a bead and said second, internal structural section advantageously includes at least one longitudinal nesting cavity designed to receive said bead, or vice versa, when said first and second structural sections are positioned by sliding them concentrically. Whether the bead is situated on the first structural section or on the second structural section and a longitudinal nesting cavity is therefore designed to receive this bead on the second structural section or on the first structural section, this makes it possible to provide an additional guide making it possible to position and to move the second, internal structural section longitudinally in the first, external structural section in an optimum manner. Also, the presence of this bead over the length of a structural section makes it possible, by placement in a longitudinal cavity as provided by the invention on the other structural section, to stiffen the telescopic rail, which makes it possible to prevent deformation of the latter, for example when the structural sections slide.

According to the present invention, said brush preferably includes a dorsal assembly portion and is removably mounted by positioning the dorsal portion in a recess formed in a wall thickness on an internal face of one of the walls of said second, internal structural section. This is particularly advantageous since the brush constitutes the element that wears fastest compared to the other elements of the telescopic rail. According to the invention, the brush can therefore be removed and replaced easily, which makes it possible to reuse the structural sections numerous times.

Said first structural section and/or said second structural section advantageously include(s) a plurality of reinforcement walls connecting a first pair of their lateral walls.

According to the invention, and equally advantageously, said first structural section and/or said second structural sections include(s) a plurality of reinforcement walls connecting a second pair of their lateral walls. In order to reinforce the structural sections and for the latter to have adequate strength, according to the invention, the reinforcement walls connect the lateral walls of each of the structural sections in pairs to confer on them an optimum stiffness.

According to the invention, said second groove of said second, internal structural section and said first groove of said first, external structural section form, when said first and second structural sections are designed to co-operate by sliding, a groove resulting from at least partial superposition of two structural sections including a longitudinal orifice formed by the at least partial alignment of said longitudinal orifice present on the front wall of said first structural section and said longitudinal orifice present on the front wall of said second structural section, said groove resulting from at least partial superposition of two structural sections being designed to receive and to retain at least partly a substantially peripheral part of a plug element, for example an edge of a tarpaulin, by means of a seal.

The expression “co-operate by sliding” is to be understood, in the context of the present invention, as referring to the at least partial covering of one element by another or at least partial insertion of one element concentrically with another. Here, in the present instance, the substantially U-shaped second groove of the internal structural section slides at least partly in the substantially U-shaped first groove of the external structural section and is therefore at least partly covered by the latter.

Clearly each of the substantially U-shaped grooves of each of the first and second structural sections is also designed to receive and to retain at least partly a substantially peripheral part of a plug element, for example an edge of a tarpaulin, by means of a seal, nesting of the first and second grooves not being indispensable for a plug element to be retained.

Each groove (first groove, second groove or groove resulting from at least partial superposition of two structural sections) makes it possible to introduce into it at least partly a substantially peripheral part of a plug element, such as for example the edge or the hem of a plastic tarpaulin, which it is possible to immobilize and to retain in this groove by means of a seal, for example, which is therefore accommodated in the groove. For example, the latter seal may be retained in said groove by two internal lips situated in the upper part of said groove.

The joining piece is preferably designed to be positioned inside an opening, of the door opening or window opening type delimited by a door frame or a window frame or of a type delimited by adjacent walls, and to co-operate with a pair of adjacent telescopic rails of a frame designed to receive a plug element, for example a tarpaulin. Each telescopic rail includes a first, external structural section including an opening part forming a substantially U-shaped first groove and a second, internal structural section including an opening part forming a substantially U-shaped second groove, said second groove of said second, internal structural section and said first groove of said first, external structural section forming, when said first and second structural sections are designed to co-operate by sliding, a groove resulting from at least partial superposition, including a longitudinal orifice formed by the at least partial alignment of a longitudinal orifice present on a front wall of said first structural section and a longitudinal orifice present on a front wall of said second structural section. Said groove resulting from at least partial superposition is moreover designed to receive and to retain at least partially a substantially peripheral part of a plug element, for example an edge of a tarpaulin. Said first end of the joining piece is designed to be nested with an end of said first, external structural profile of a first telescopic rail, said second end of said joining piece being designed to be nested with an end of said second, internal structural section of a second telescopic rail adjacent to said first telescopic rail. A substantially peripheral part of said plug element is designed to be accommodated in the opening forming a cavity of the groove of the first structural section or of the second structural section or in said groove resulting from at least partial superposition of two structural sections, each groove being designed to receive at least partially and with a tight fit a seal for fixing said substantially peripheral part of said plug element in said groove.

The term “nested” is to be understood in the context of the invention to refer to an element at least partly covered and retained by another or by at least partial insertion of an element in another, for example concentrically. In this instance, for example, an end of each telescopic rail is nested at least in a part of each end of the joining piece.

Said first end of said joining piece includes a first longitudinal groove designed to be at least partly accommodated in the opening forming a cavity of said groove of said external structural section of the first rail and said second end of said joining piece includes a second longitudinal groove designed to be at least partly accommodated in the opening forming a cavity of said groove of said internal structural section of the adjacent second rail, each of the grooves being designed to receive said seal at least partly on top of a part of said plug element superposed on said joining piece.

In this way, the first groove at the first end of the joining piece accommodated in the opening forming a cavity of the groove of the external structural section and the second groove present at the second end of the joining piece accommodated in the opening forming a cavity of the groove of the internal structural section form continuous fixing means for the plug element present on each structural section.

When the seal is placed in the groove of the external structural section of a first rail adjacent the joining piece it makes it possible to fix a substantially peripheral part of the plug element in the groove of the external structural section. The same seal is also at least partly accommodated in the opening forming a cavity of the first groove at the first end of the joining piece, on top of the substantially peripheral part of the plug element that covers the joining piece. The seal preferably extends at least far enough to come into contact with at least one of the lateral walls of the opening to be plugged. Also, the seal of the adjacent second rail is placed at least partly in the groove of the internal structural section of the second rail, on top of the plug element, and therefore fixes a substantially peripheral part of the plug element, namely the peripheral part perpendicular to the peripheral part accommodated in the first rail.

The same seal is also at least partly accommodated in the opening forming a cavity of the second groove present at the second end of the joining part, on top of said substantially peripheral part of the plug element that covers the joining piece.

Also, the joining piece according to the invention is preferably a corner piece and is advantageously substantially L-shaped so that said first rail is oriented substantially perpendicularly to said second rail.

The joining piece is further characterized in that it has a flap on a front face, said flap being designed to cover at least partly a front face of said first, external structural section of a first telescopic rail and a front face of said second, internal structural section of a second telescopic rail.

The presence of the flap makes it possible to plug any gaps created between the walls of the opening and the joining piece of the frame, thus ensuring the impermeability of the system in the corners of the opening to be plugged.

The joining piece optionally includes between said first end and said second end a solid part designed to receive on one side, abutted against it, said external structural section of the first rail and on the other side, abutted against it, said internal structural section of said second rail.

Dirt is then unable to penetrate into the structural section via the corner piece since on the one hand the passage is blocked at the level of the seal-plug element junction and on the other hand since the part of the joining piece in which the seal is not accommodated is solid.

In one particular embodiment, said solid part of said joining piece is made of a rubbery type flexible material.

In this way, the hollow part of the structural section is plugged and passage of dust beyond the seal-plug element pair prevented.

In a variant of the present invention, said joining part has a third end and is substantially T-shaped, said first end being designed to be nested with an end of said first, external structural section of a first telescopic rail, said second end of said joining piece being designed to be nested with an end of said second, internal structural section of a second telescopic rail adjacent said first telescopic rail, said first rail being substantially aligned with said second rail, said third end being designed to be nested with an end of said first, external structural section or said second, internal structural section of a third rail, said third rail being substantially perpendicular to said first and second rails.

Said T-shaped joining piece preferably includes between its ends a solid part designed to receive on one side, abutted against it, said external structural section of the first rail, on a second side, abutted against it, said internal structural section of said second rail, and on a third side, abutted against it, said internal or external structural section of said third rail.

In particular embodiment, said solid part of said joining piece is made of a flexible material of rubbery type.

Said third end preferably includes a third longitudinal groove designed to be at least partly accommodated in the opening forming a cavity of said groove of said external structural section or in said groove of the internal structural section of said third rail.

The presence of a T-shaped joining piece is particularly recommended when the opening to be plugged has large dimensions, i.e. a width of at least 150 cm (or a multiple of at least 150 cm) and a height of 150 cm (or a multiple of at least 150 cm).

This opening having large dimensions, it is difficult for the person skilled in the art working alone to install the plugging system in order to plug this opening with a single plug element. The presence of a T-shaped joining piece then makes it possible to install at least a third rail dividing the opening defined by the frame into two openings of smaller size and each of which can easily be covered by a plug element.

It is to be noted that for openings of great height, i.e. at least 150 cm (or a multiple of at least 150 cm) high, a plurality of telescopic rails can be connected two by two by a junction piece having a first end facing a second end so that two adjacent rails connected to the same joining piece are aligned with one another.

Other features, details and advantages will emerge from the nonlimiting description given hereinafter with reference to the appended drawings.

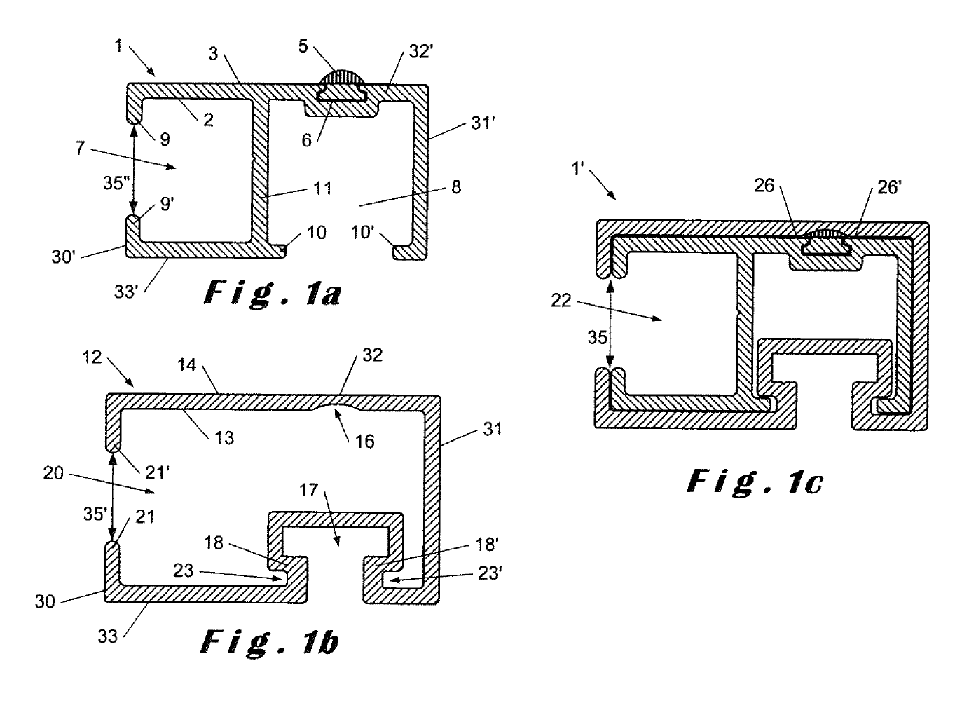

FIGS. 1a to 1c are diagrammatic views of a first telescopic rail.

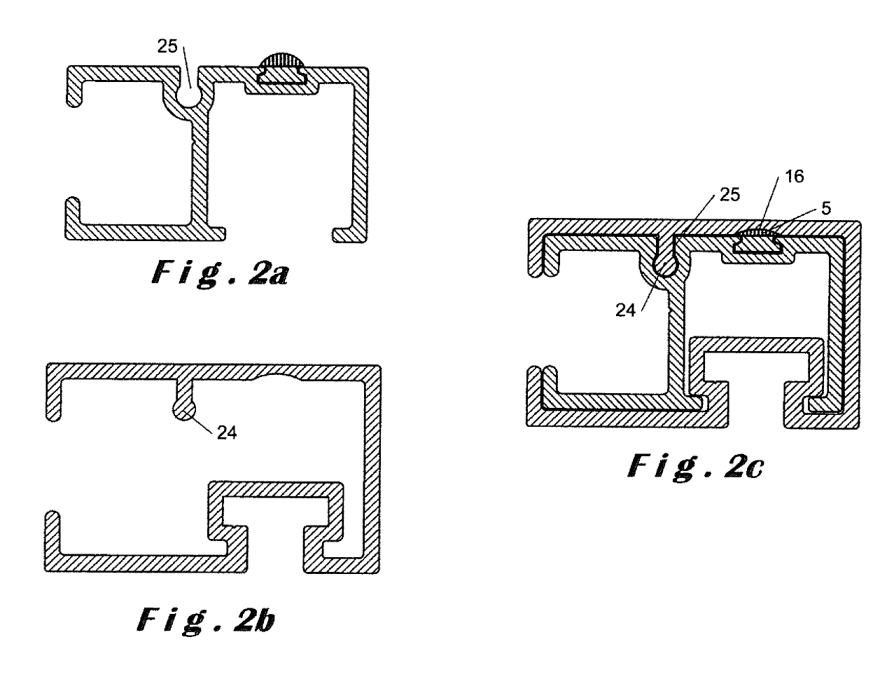

FIGS. 2a to 2c are diagrammatic views of another telescopic rail.

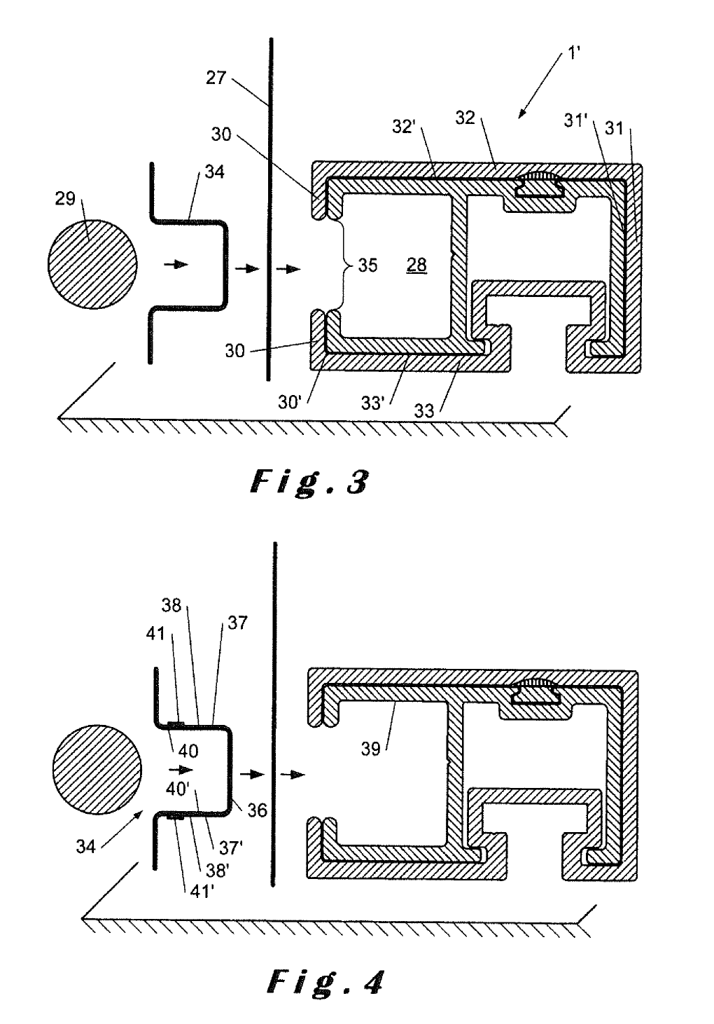

FIG. 3 is a diagrammatic sectional view of the plugging system.

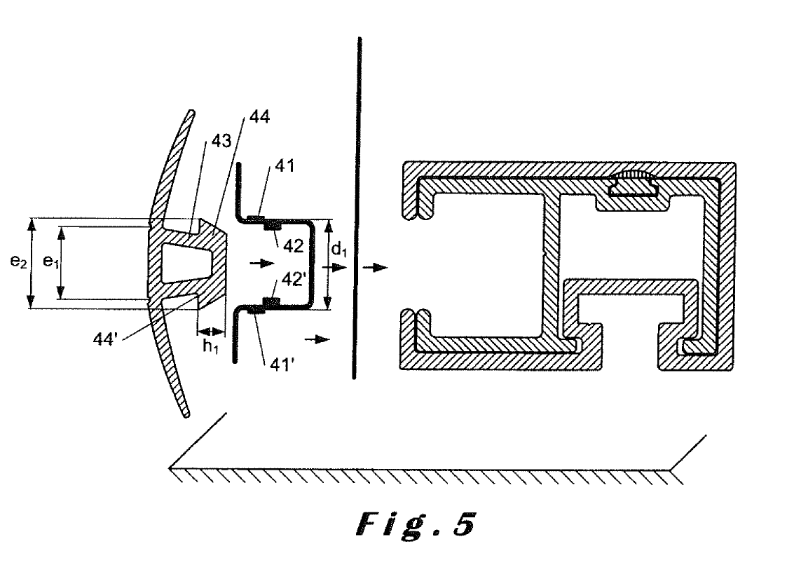

FIG. 4 is a diagrammatic sectional view of a first embodiment of the plugging system.

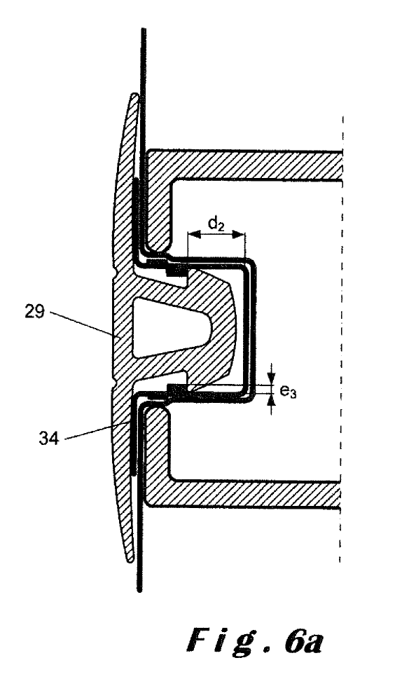

FIG. 5 is a diagrammatic sectional view of a second embodiment of the plugging system.

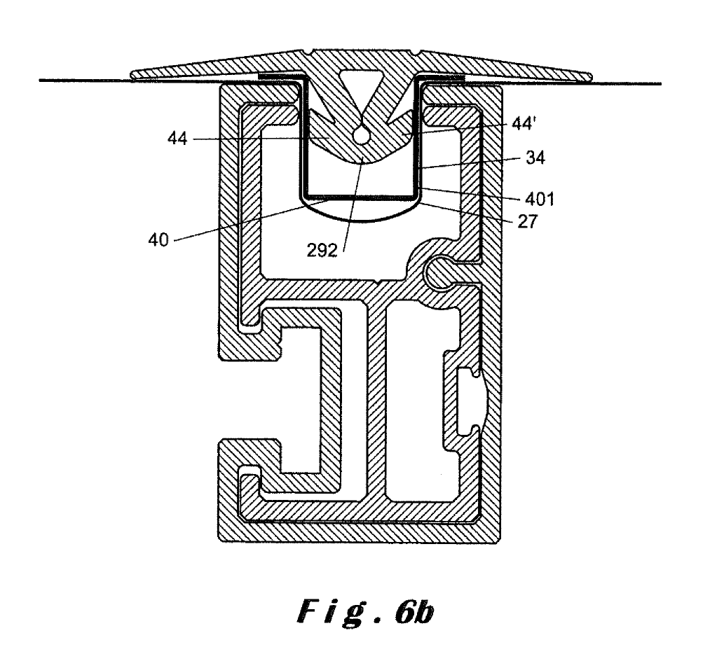

FIG. 6a is a diagrammatic sectional view of a third embodiment of the plugging system.

FIG. 6b is a diagrammatic sectional view of a fourth embodiment of the plugging system.

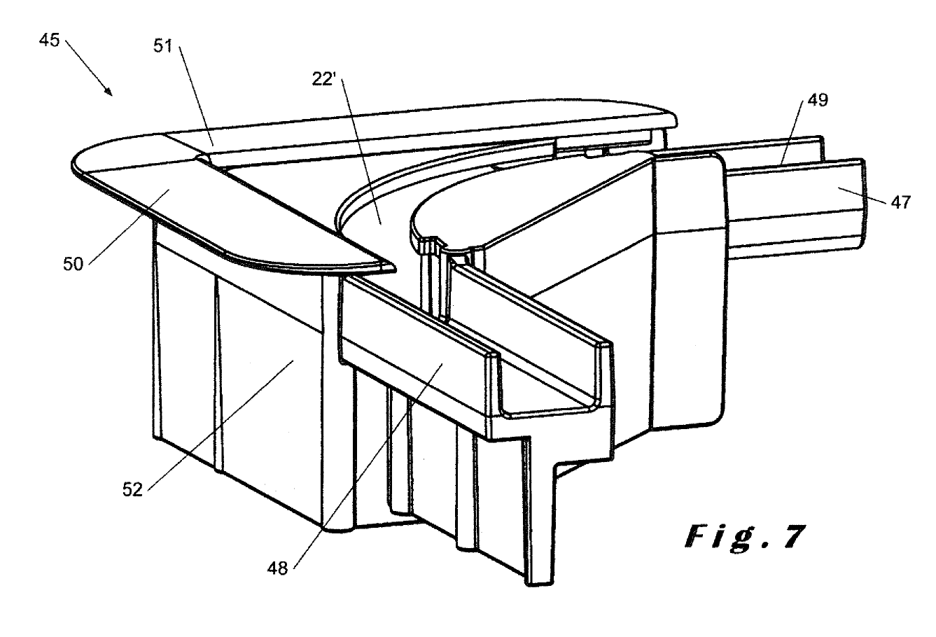

FIG. 7 is a perspective view of the L-shaped joining piece according to a preferred embodiment.

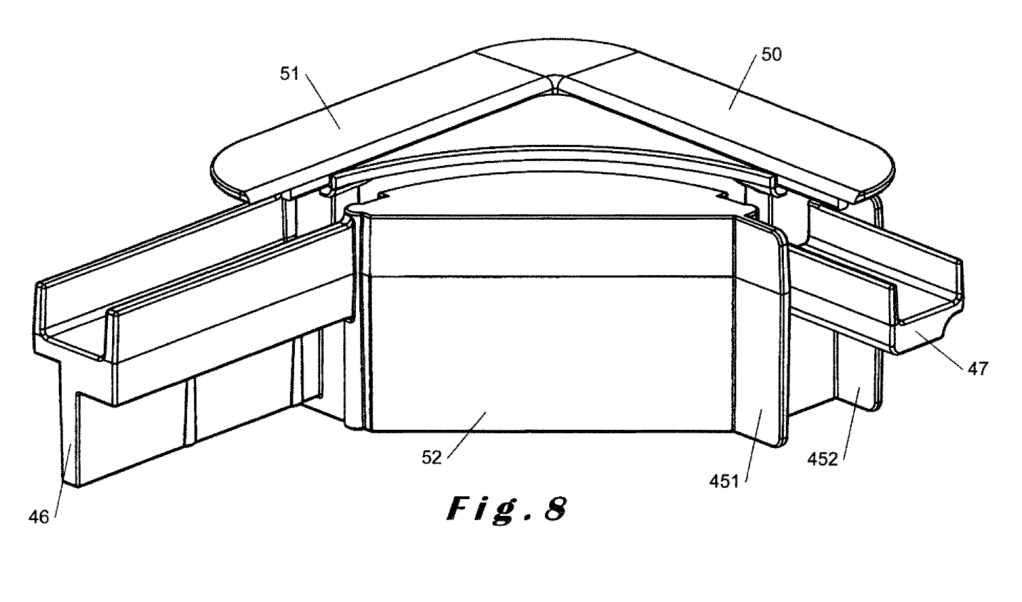

FIG. 8 is a perspective view of the L-shaped joining piece according to another preferred embodiment.

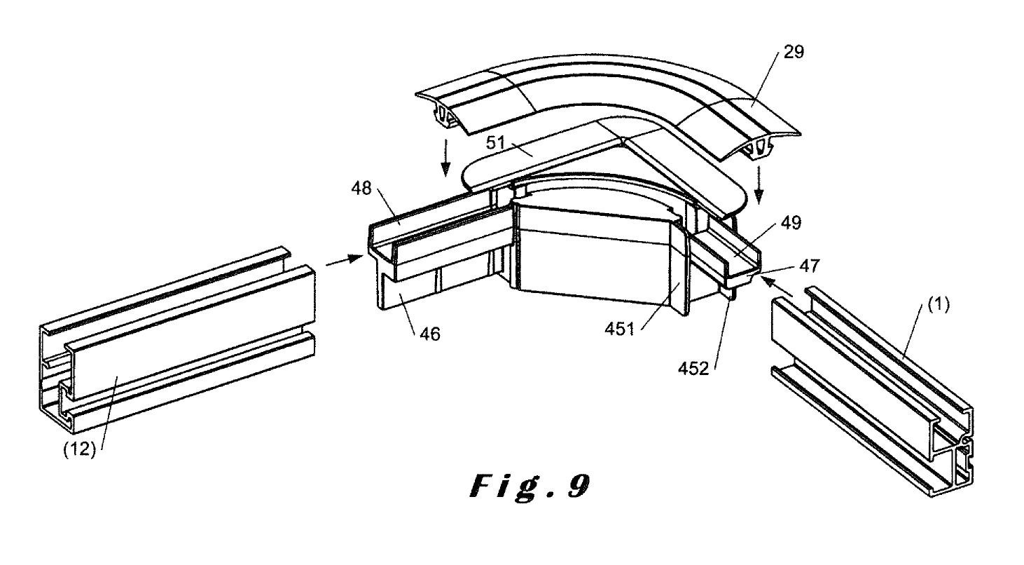

FIG. 9 is an exploded view of a seal, joining piece and rails assembly.

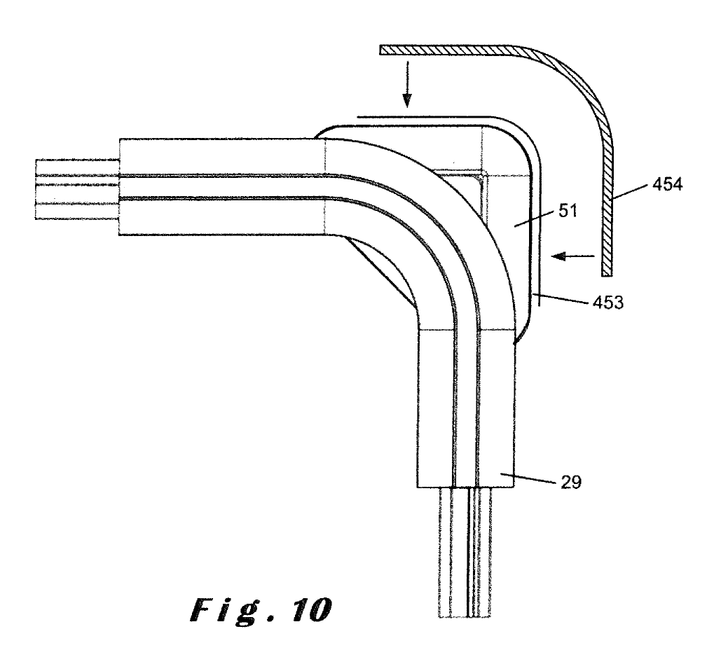

FIG. 10 a top view of the L-shaped joining piece according to an alternative embodiment.

In the figures, identical or analogous elements bear the same references.

According to the invention, the system for plugging an opening includes a frame formed by at least four telescopic rails, each rail including a front wall 30, 30′, a dorsal wall 31, 31′ opposite the front wall, and two connecting walls 32, 32′ and 33, 33′ connecting the front and dorsal walls.

The connecting wall 32, 32′ of each structural section being designed to be placed in contact against one side of an opening of door or Window opening type delimited by a door or window frame or of a type delimited by adjacent walls.

FIG. 1a illustrates an internal structural section 1 of a rail 1′ of a frame, the walls of this internal structural section 1 having an internal face 2 and an external face 3. The connecting wall 32′ includes a brush 5 removably mounted in a recess 6. Also, this internal structural section includes a second groove 7 and a fifth groove 8 that are substantially U-shaped and separated by a wall 11, each of these two grooves 7, 8 including two internal lips 9, 9′ and 10, 10′. The internal lips 9, 9′ each extending from one of the connecting walls of the internal structural section form a longitudinal orifice forming an opening 35″ of the second groove 7 of the internal structural section.

The structural sections are preferably made of PVC or aluminum.

FIG. 1b illustrates an external structural section 12 the walls of which have an internal face 13 and an external face 14. The connecting wall 32 includes on its internal face 13 a channel 16 designed to receive the brush 5 (illustrated in FIG. 1a) of the internal structural section 1. Also, the external structural section 12 includes a third U-shaped groove 17 optionally including two shoulders 18, 18′ formed in the lateral walls of said third groove 17, said third groove 17 being situated on a connecting wall 33 opposite the connecting wall 32 including the channel 16. Also, the external structural section 12 includes a substantially U-shaped first groove 20. Each of two internal lips 21, 21′ extending from one of the connecting walls of the external structural section forms a longitudinal orifice forming an opening 35′ of the first groove 20 of the external structural section.

FIG. 1c illustrates a telescopic rail according to the invention in which the internal structural section 1 is designed to co-operate by sliding in the external structural section 12. The brush 5 present on a connecting wall 32 of the internal structural section 1 is received by the channel 16 present in the connecting wall 32 of the external structural section 12 (on its internal face 13) so that the brush 5 does not constitute a thickness causing a gap between the structural sections 1, 12. Also since the brush 5 is situated in the channel 16, the latter forms a guide element when the internal structural section 1 slides in the external structural section 12. The internal lips 9 and 9′ of the internal structural section 1 lies alongside the internal lips 21, 21′ of the external structural section 12, the sliding of the two structural sections 1, 12 forming a groove 22 resulting from at least partial superposition of two structural sections including a longitudinal orifice 35 formed by the at least partial alignment of the longitudinal orifice 35′ present on the front wall 30 of said first structural section 12 and the longitudinal orifice 35″ present on the front wall 30′ of the second structural section 1. The groove 22 resulting from at least partial superposition of two structural sections is moreover designed to receive at least partly a substantially peripheral part of a plug element 27, for example an edge of a hem of a tarpaulin (not illustrated in FIG. 1c).

Also, the two internal lips 10, 10′ of the internal structural section 1 are positioned in the longitudinal rails 23, 23′ formed by the shoulders 18, 18′ present at the level of the third U-shaped groove 17 of the external structural section 12. In this way, if nut and bolt immobilizing means (not shown) are used and tightening a nut causes it to abut against the lower parts of the shoulders, the lips 10, 10′ of the internal structural section 1 are compressed in the longitudinal rails 23, 23′ so that the two structural sections 1, 12 are temporarily fastened together. Also, since the brush 5 is at least partly accommodated in the channel 16, the internal structural section 1 can bear against the external structural section 12 over a narrow area of contact, along two lateral parts 26, 26′ of the internal face 13 of the connecting wall 32 of the structural section 12, these two lateral parts 26, 26′ being situated on opposite sides of the channel 16.

FIGS. 2a to 2c illustrate another telescopic rail according to the invention. The same elements as those in FIGS. 1a to 1c are carried over except that the second external structural section 12 includes a bead 24 designed to be received in a longitudinal nesting cavity 25 situated on the internal structural section 1. As illustrated in FIG. 2c, this bead 24 is inserted, i.e. nested, in the longitudinal nesting cavity 25 which serves as a guide element during sliding of the structural sections 1, 12. This nesting also makes it possible to stiffen the telescopic rail and also to minimize the gap between the two structural sections 1, 12.

FIG. 3 is a diagrammatic sectional view of the plugging system. That system is made up of a plug element, for example a tarpaulin 27 designed to cover the opening, first fixing means 28 present on the frame, and second fixing means 29. The plugging element preferably includes a zip fastener.

The first fixing means 28 comprise an opening defined by the longitudinal orifice 35 of the groove resulting from at least partial superposition of two structural sections 22 and the opening part forming a cavity of the groove resulting from at least partial superposition of two structural sections 22 in which a substantially peripheral part of a plug element 27 is designed to be accommodated. The second fixing means 29 comprise a seal, for example of circular section.

Said seal is advantageously made of a flexible material and is designed to be fixed with a tight fit between the lips 9, 9′ and 21, 21′ of each of the structural sections of the telescopic rail defining the opening 35 of the groove 22 and thus to fix thereto the substantially peripheral part of a plug element 27. The seal 29 is preferably made up of a plurality of seals.

The plugging system further includes at least one means 34 for retaining a substantially peripheral part of a plug element 27. The retaining means 34 have a first predetermined profile complementary to a second predetermined profile formed by the lips 21, 21′ and 9, 9′ defining the opening 35 of the groove 22, these retaining means 34 being designed to be accommodated in the latter groove, between a substantially peripheral part of a plug element 27 and the seal 29, superposed on top of the plug element. In this way, on the one hand, said plug element 27 is retained on the frame and, on the other hand, the retaining means 34 are positioned so that they are able to receive the seal 29, the latter having a third predetermined profile designed to co-operate with the first predetermined profile of the retaining means 34. The retaining means 34 according to the invention are preferably made of a rigid material. In one advantageous embodiment of the system according to the invention the retaining means 34 advantageously comprise a plurality of retaining means.

The retaining means 34 and the seal 29 preferably form a single element.

In a particularly advantageous embodiment of the system shown in FIG. 4, the retaining means 34 have a back wall 36 and two facing lateral walls 37, 37′ so that the cross section of said retaining means 34 is substantially U-shaped.

Each lateral wall 37, 37′ of the retaining means 34 has an external face 38, 38′ oriented toward the internal face 39 of the groove 22 of the telescopic rail. Also, each lateral wall 37, 37′ of said retaining means 34 has on an external face 38, 38′ at least one protuberance 41, 41′ oriented toward the internal face 39 of the groove 22.

In a third embodiment of the system according to the invention shown in FIG. 5, each internal face 40, 40′ of each lateral wall 37, 37′ of the retaining means 34 includes at least one protuberance 42, 42′ oriented in a direction opposite that of the protuberance 41, 41′ connected to the external face 38, 38′ of each lateral wall 37, 37′. Also, the seal 29 includes a longitudinal projection 43 having a first predetermined thickness e1 and terminating in first and second shoulders 44, 44′ having a predetermined height h1 to form an assembly having a second predetermined thickness e2.

The lateral walls 37, 37′ of the retaining means 34 are separated from one another by a predetermined distance d1 such that d1≦e2, each shoulder 44, 44′ of the seal being designed to be placed between the back wall 36 of the retaining means and each protuberance on the internal faces 40, 40′ of the lateral walls 37, 37′ of the retaining means.

Each of the protuberances 42, 42′ present on each internal face 40, 40′ of the retaining means 34 is advantageously defined by a third predetermined thickness e3 and is at a second predetermined distance d2 from the back wall 36 of the retaining means 34 such that e3≧e2−e1 and/or h1≧d2 (FIG. 6).

As shown in FIG. 6a, the protuberances 41, 41′ present on the external faces 38, 38′ of the lateral walls 37, 37′ of the retaining means 34 are designed so that, when the retaining means 34 are accommodated in the groove 22 of a telescopic rail 1′, they are in contact with the internal lips 9, 9′ and 21, 21′ present on each structural section 1, 12 of the telescopic rail and forming an opening 35 through which the retaining means 34 are inserted.

In a preferred embodiment of the invention shown in FIG. 6b, the longitudinal projection 43 of the seal 29 optionally has an arrowhead-shaped cross section terminating at a distal end 292 designed to be oriented toward the retaining means 34. Each of the first and second shoulders 44, 44′ of the longitudinal projection is designed to be in contact with each internal face 40, 40′ of the retaining means when the seal 29 is mounted with a tight fit in the retaining means 34.

In one particular embodiment, adjacent first and second rails 1′, 1″ of the frame are nested in an L-shaped joining piece 45, which is preferably at least partly solid, so that the rails are non-parallel, in particular substantially perpendicular.

FIG. 7 is a perspective view of the L-shaped joining piece 45.

This joining piece 45 has a first end 46 and a second end 47. The joining piece 45 is designed to co-operate with a pair of adjacent telescopic rails 1′, 1″ of the frame. The first end 46 of the joining piece 45 is designed to be nested with one end of the first, external structural section 12 of a first telescopic rail 1′ and the second end 47 of the joining piece 45 is designed to be nested with one end of the second, internal structural section 1 of a second telescopic rail 1″ adjacent the first telescopic rail 1′.

The first end 46 of the joining piece 45 includes a first longitudinal groove 48 designed to be accommodated at least partly in the groove 20 of the external structural section 12 of the first rail 1′ and thus to form first mutual coupling means with that rail. The second end 47 of the joining piece 45 includes a second longitudinal groove 49 designed to be at least partly accommodated in the groove 7 of said internal structural section 1 and thus to form second mutual coupling means with that rail. Also, each of the grooves of the joining part 45 being designed to receive the seal 29, on top of a part of the plug element 27 superposed on the joining part 45.

Also, each seal 29 is preferably extended so that a free part of the seal of the second rail 1″ is superposed on another free part of the seal of the first rail 1′. In this context, each free part of the seal constitutes means for holding the seal. In this way, to demount the plug member from the frame, it suffices the person skilled in the art to take hold of the free part of each seal to dislodge the seal from the grooves in the joining part and the adjacent rails in which the seals are accommodated.

The joining piece is further characterized in that it includes a flap 50 on a front face 51, this flap 50 being designed to cover at least partly a front face 30 of the first, external structural section 12 of the first telescopic rail 1′ and a front face 30′ of the second, internal structural section 1 of the second telescopic rail 1″.

According to one embodiment, the joining piece 45 includes a third longitudinal groove 22′ on the front face 51 designed to connect the first groove 48 and the second groove 49 of the joining piece and to form a single continuous groove.

In one preferred embodiment of the joining piece, at least one of the longitudinal grooves 48, 49 and 22′ includes an opening formed by a longitudinal orifice defined by two internal lips each extending from one of the lateral walls of the groove, the seal being designed to be held tightly by each lip of the opening of the groove in which the substantially peripheral part of the plug element is accommodated and thus to fix that part of the plug element to the rail.

In one particular embodiment shown in FIGS. 8 and 9, the joining piece according to the invention includes a pair of lateral flaps 451, 452. The lateral flaps 451, 452 are disposed on either side of the second end 47 of the joining piece to form a first gap between that second end 47 and a first lateral flap 451 and a second gap between that second end 47 and a second lateral flap 452. Each gap is designed to receive with a tight fit at least an end part of the second, internal structural section 1 of the second telescopic rail 1″.

FIG. 10 illustrates one particular embodiment of the joining piece according to the invention. In this particular embodiment, the front flap 50 includes a front groove 453 designed to receive a front seal 454 on top of a part of said plug element 27.

In a variant, the joining piece 45 includes a third end and is substantially T-shaped. The first end 46 is designed to be nested with one end of the first, external structural section 12 of the first telescopic rail 1, the second end 47 of the adjoining piece is designed to be nested with one end of the second, internal structural section 1 of the second telescopic rail 1″ adjacent the first telescopic rail 1′, the first rail 1′ being substantially aligned with the second rail 1″. The third end is designed to be nested with one end of the first, external structural section 12 or of the second, internal structural section 1 of a third rail substantially perpendicular to the first rail 1′ and the second rail 1″.

The T-shaped joining piece includes between its ends a solid part 52 designed to receive on one side, abutted against it, the external structural section 12 of the first rail 1′, on a second side, abutted against it, the internal structural section 1 of the second rail 1″, and on a third side, abutted against it, the internal or external structural section of the third rail. The solid part 52 is preferably made from a flexible material of rubbery type.

Also, the third end of the joining piece includes a third longitudinal groove designed to be accommodated at least partly in the groove of the external structural section 12 or in the groove of the internal structural section 1 of the third rail.

The presence of a T-shaped joining piece is particularly recommended if the opening to be plugged has large dimensions, i.e. a width of at least 150 cm (or a multiple of at least 150 cm) and a height of at least 150 cm (or a multiple of at least 150 cm).

This opening having large dimensions, it is difficult for the person skilled in the art working alone to install the plugging system so as to plug this opening with a single plug element. The presence of a T-shaped joining piece then makes it possible to install at least one third rail dividing the opening defined by the frame into two openings of smaller size each of which can easily be covered by a plug element.

It is to be noted that for openings of great height, i.e. having a height at least equal to 150 cm (or a multiple of at least 150 cm), a plurality of telescopic rails can be connected two by two by a joining piece having a first end facing a second end so that two adjacent rails connected to the same joining piece are aligned with each other.

The frame is preferably a telescopic system including at least four telescopic rails. The frame is moreover designed to be positioned in an opening of the door opening or window opening type delimited by a door frame or a window frame or of a type delimited by adjacent walls, said telescopic system being further designed to receive a plug element, for example a tarpaulin, and further including at least four joining pieces, in particular a corner piece, in which two perpendicular adjacent rails are nested.

Said two perpendicular adjacent rails nested in a joining piece are advantageously also connected by compensation means, for example by a flat spring.

The presence of these compensation means is particularly recommended when the stiffness of the frame is insufficient and the rails may buckle toward the interior of the opening. This is the case in particular for telescopic rails forming a frame designed to be nested in an opening having large dimensions, for example at least 150 cm (or a multiple of at least 150 cm) by 150 cm (or a multiple of at least 150 cm). Also, to hold each rail against the sides of the opening, compensation means may be fitted. The latter push each rail against the facing sides of the opening.

Compensation means are installed in each corner of the frame and include a flexible strip, for example of the spring steel strip type, also termed a flat spring, and two fasteners, for example of the nut and bolt type passing through the strip, the bolt of which passes through one of the ends of the strip and is screwed into a nut accommodated in the rail in question.

The strip is then disposed inside the frame to face a junction piece. The strip is fixed to each of the adjacent frames so as to be pushed into the corner of the frame so as to assume a circular arc shape the center of curvature of which is oriented toward the center of the opening defined by the frame.

In this way, the compensation means create a circular deployment operative on each rail so that the nesting of these rails in their joining piece is consolidated by the circular thrust action resulting from the presence of the strips, each placed in a circular arc.

For example, the strip may have a thickness between 1 mm and 2 mm inclusive and a length between 60 cm and 80 cm inclusive.

The fasteners of the compensation means optionally include a series of slots (at least one slot) on each rail and in which each end of the strip is inserted.

In a preferred embodiment, for openings having large dimensions, i.e. a width and/or a height of at least 150 cm (or a multiple of at least 150 cm), the opening is plugged by placing at least two frames, one after the other, in the direction of the length and/or the height, each of the two frames including two pairs of rails interconnected by four L-shaped joining pieces. In this context, each of the adjacent frames then has a rail in contact with a rail of the other frame.

In particular, the person skilled in the art will take care to orient the L-shaped joining pieces so that two adjacent joining pieces, each belonging to a separate frame, are arranged so that a first end 46 of a first joining piece 45 of a first frame are disposed adjacent a second end 47 of a second joining piece 45′ of a second frame so that the effect of the circular thrust of the springs placed on the first frame compensate the circular thrust effect of the springs placed on the second frame so as to stabilize the telescopic rails in a predetermined sliding position.

In order to stabilize the frame additional compensation means may optionally be placed between two opposite large rails.

The installation of the plugging system preferably including telescopic rails includes the following steps:
joining two adjacent rails by means of a joining piece 45 to form a frame, the joining piece 45 including a first end 46 designed to be connected to a first rail 1′ and a second end 47 designed to be connected to a second rail 1″,
placing the frame inside an opening,
optionally lengthening the telescopic rails by sliding an internal structural section 1 in an external structural section 12 forming the telescopic rail so that the joining pieces 45 come to abut against the corners of the opening,
locking the internal structural section 1 and the external structural section 12 by tightening locking means, optionally followed by mounting compensation means to stiffen the frame,
inserting at least one substantially peripheral part of a plug element 27 in a groove present in each rail or in a groove formed by the sliding of a second groove (7) of a second, internal structural section (1) in a first groove (20) of a first, external structural section (12) of a telescopic rail when said first and second structural sections are designed to co-operate by sliding, and
positioning with a tight fit at least one seal 29 through the opening of the groove 22 of each rail to fix thereto the substantially peripheral part of the plugging element so as to form a system for plugging the opening.
   Installing the plugging system further includes a step before that of positioning a seal 29 in which retaining means 34 having a first predetermined profile complementary to the second profile formed by the lips defining said opening 35 of the groove 22 and the opening part forming the cavity of the groove is placed in the groove 22 between the substantially peripheral part 27 of a plug element and the seal 29, superposed on top of said at least one substantially peripheral part 27 of a plug element so as to retain the plug element on the frame and to receive the seal 29 having a third predetermined profile designed to co-operate with the first predetermined profile of the retaining means 34.

The plugging method according to the invention is advantageously characterized in that it includes, before the step of joining at least four rails two by two to form the frame, a step of telescopic deployment of each rail of said frame so that at least one joining piece 45 comes to abut against one of the corners of the opening. Each rail is a telescopic rail comprising a first, external structural section 12 and a second, internal structural section 1, the first and second structural sections being designed to co-operate by sliding.

The step of positioning at least one seal 29 in the groove 22 of each rail is preferably effected both in the groove 22 of a rail of the frame and in a groove 48 present at the first end 46 of the joining piece 45, the groove 48 at the first end 46 of the joining piece 45 preferably being designed to receive retaining means 34. In this way at least a substantially peripheral part of the plugging element 27 is connected to the joining piece 45.

Alternatively, said step of positioning at least one seal 29 in the groove 22 of each rail is effected both in the groove 22 of a rail of the frame and in a groove 49 present at the second end 47 of the joining piece 45, the groove at the second end 47 of the joining piece 45 being also designed to receive retaining means 34.

The plugging method optionally further includes a step of inserting with a tight fit a front seal 454 in a front groove 453 disposed on a front flap 50 of at least one joining piece on top of a part of said plug element 27.

In the context of the present invention it is clear that the opening is not limited to an opening defined by a door frame or window frame but also includes an opening created, generally speaking, by a perimeter defined by at least four planes parallel two by two. The perimeter is preferably formed by four pairs of secant planes, for example, by a pair of opposite walls connected by a ceiling and a floor.

The frame is preferably connected to the walls, the floor and the ceiling by fitting a temporary seal, for example an expandable foam seal.

It is clear that the present invention is in no way limited to the embodiments described above and that many modifications may be made thereto without departing from the scope of the appended claims.

1. A system for plugging an opening, of the door or window opening type delimited by a door frame or window frame or of a type delimited by adjacent walls, including:
a plug element, for example a tarpaulin (27) designed to cover said opening,
a frame, which is designed to be positioned inside said opening, of the door or window opening type, made up of at least four structural sections each forming a rail (1′) of said frame, each structural section comprising a front wall (30), a dorsal wall (31) and two connecting walls (31, 33) and having an opening part forming a cavity of a substantially U-shaped groove, and having first fixing means (28), and
second fixing means (29),
said first and second fixing means (28, 29) being designed to co-operate with one another to retain said plug element (27) on said frame and to be separable so as to allow the withdrawal of said plug element on the frame, said first fixing means being an opening (35) defined by a longitudinal orifice present on said front wall (30) of each structural section, said opening (35) being defined by two adjacent parts formed by two internal lips (21, 21′) each extending from one of the connecting walls, said groove (22) of said structural section being designed to accommodate a substantially peripheral part of the plug element (27) passing through said opening (35), said second fixing means being formed of at least one peripheral seal (29) designed to be held with a tight fit by each internal lip (21, 21′ and 9, 9′) of said opening (35) of said groove (22) in which said substantially peripheral part of said plug means (27) is accommodated and fixed, characterized in that it includes means (34) for retaining the tarpaulin (27) having a first predetermined profile complementary to a second predetermined profile formed by said opening part forming a cavity of a groove and by said adjacent lips of said opening of said groove, said retaining means (34) being designed to be at least partly accommodated in said groove of said structural section forming said rail (22), between said substantially peripheral part of the plug element (27) and said seal (29), superposed on top of said substantially peripheral part of said plug element (27) so as to retain it on said frame and so as to receive said at least one peripheral seal (29) having a third predetermined profile designed to co-operate with said first predetermined profile of said retaining means (34).

2. The system as claimed in claim 1, characterized in that at least one of said rails of the frame (1′) includes a first, external structural section (12) and a second, internal structural section (1) designed to co-operate by sliding to form a telescopic rail including:
a first, external structural section (12) comprising a front wall (30), a dorsal wall (31) and two connecting walls (32, 33), each of the walls having an internal face (13) and an external face (14), said first structural section (12) including an opening part forming a cavity of a first substantially U-shaped groove (20), said front wall (30) including a longitudinal orifice forming an opening (35′) of said first groove (20) the adjacent parts of which are formed by two internal lips (21, 21′) each extending from one of the connecting walls (32, 33), and
a second, internal structural section (1) comprising a front wall (30′), a dorsal wall (31′) and two connecting walls (32′, 33′), each of the walls having an internal face (2) and an external face (3), said external face (3) of one of said connecting walls of said second structural section including a brush (5) over at least part of its length, said second structural section (1) including an opening part forming a cavity of a second substantially U-shaped groove (7), said front wall (30′) including a longitudinal orifice forming an opening (35″) of said second groove (7) the adjacent parts of which are formed by two internal lips (9, 9′) each extending from one of the connecting walls (32′, 33′),
said second groove (7) of said second, internal structural section (1) and said first groove (20) of said first, external structural section (12) forming, when said first structural section (12) and said second structural section (1) are designed to co-operate by sliding, a groove resulting from at least partial superposition of two structural sections (22) including a longitudinal orifice (35) formed by the at least partial alignment of said longitudinal orifice (35′) present on the front wall (30) of said first structural section (12) and said longitudinal orifice (35″) present on the front wall (30′) of said second structural section (1), said groove resulting from at least partial superposition of two structural sections (22) being designed to receive and to retain at least partly a substantially peripheral part of said plug element (27).

3. The system as claimed in claim 1, characterized in that two adjacent rails (1′, 1″) of the frame are nested in a preferably solid joining piece (45) so that the rails are not parallel, in particular substantially perpendicular.

4. The system as claimed in claim 3, characterized in that said joining piece (45) has a first end (46) including means for mutual coupling with an end of said external structural section (12) of a first telescopic rail (1′) and a second end (47) including means for mutual coupling with an end of said internal structural section (1) of an adjacent second telescopic rail (1″), said joining piece having at said first end (46) a groove (48) designed to co-operate with said groove (20) of said external structural section of the first rail (1′) and having at the second end (47) a groove (49) designed to co-operate with said groove (7) of said internal structural section (1) of said second rail (1″).

5. The system as claimed in claim 4, characterized in that said joining piece (45) includes a groove (22′) on a front face (51) designed to connect said groove of said first end and said groove of said second end of the joining piece and to form a single continuous groove.

6. The system as claimed in claim 1, characterized in that said retaining means (34) include a plurality of retaining means (34).

7. The system as claimed in claim 1, characterized in that retaining means (34) include a back wall (36) and two facing lateral walls (37, 37′), to each lateral face there corresponds an internal face (40, 40′) oriented toward the interior of the retaining means (34), said lateral walls (37, 37′) extending from said back wall (36) and also including an external face (38, 38′) designed to face an internal face (39) of said substantially U-shaped groove of a structural section (22) forming a rail.

8. The system as claimed in claim 7, characterized in that said external face (38, 38′) of each lateral wall (37, 37′) of said retaining means (34) is designed to face an internal face (39) of a groove (22) formed when said first and second structural sections of a telescopic rail (1′) are designed to co-operate by sliding, each of the structural sections including an opening part forming a cavity of a substantially U-shaped groove.

9. The system as claimed in claim 7, characterized in that each external face (38, 38′) includes at least one protuberance (41, 41′) extending from the external face (38, 38′) and is designed to force nesting of said retaining piece (34) in said groove (22) formed in the opening of a structural section forming a rail of said frame or formed if said first structural section (12) and said second structural section (1) are designed to co-operate by sliding and form a groove defined by the sliding of said second groove in said first groove.

10. The system as claimed in claim 9, characterized in that each internal face (40, 40′) of each lateral wall (37, 37′) of said retaining means (34), includes at least one protuberance (42, 42′) oriented in a direction opposite that of said projection (41, 41′) on the external face (38, 38′) and in that said seal (29) has a longitudinal projection (43) having a first predetermined thickness e1 and terminated by first and second shoulders (44, 44′) having a predetermined height h1 to form an assembly having a second predetermined thickness e2, said lateral walls (37, 37′) of the retaining means (34) being separated from one another by a predetermined distance d1 such that d1≦e2, each shoulder (44, 44′) of said seal (29) being designed to be placed between said back wall (36) of said retaining means (34) and each protuberance (42, 42′) present on said internal faces (40, 40′) of the lateral walls (37, 37′) of said retaining means (34).

11. The system as claimed in claim 10, characterized in that said protuberance (42, 42′) on each internal face (40, 40′) of said retaining means (34) has a third predetermined thickness e3 and is placed at a second predetermined distance d2 from said back wall (36) of the retaining means (34) such that e3≧e2−e1 and/or h1≧d2.

12. The system as claimed in claim 10, characterized in that said longitudinal projection (43) of the seal (29) has an arrowhead-shaped cross section terminating at a distal end (292), said arrowhead being designed to be oriented toward the retaining means (34), each of the first and second shoulders (44, 44′) of the longitudinal projection being designed to be in contact with each internal face (40, 40′) of the retaining means when said seal (29) is mounted with a tight fit in the retaining means (34).

13. The system as claimed in claim 1, characterized in that said at least one peripheral seal (29) includes a plurality of longitudinal seals.

14. The system as claimed in claim 1, characterized in that said retaining means (34) are made from a rigid material.

15. The system as claimed in claim 1, characterized in that said seal (29) is made from a flexible material.

16. The system as claimed in claim 1, characterized in that said retaining means (34) and said seal (29) form a single element.

17. The system as claimed in claim 3, characterized in that the frame designed to be positioned inside an opening is a telescopic system including at least four telescopic rails to receive a plug element, for example a tarpaulin, each rail being connected to an adjacent, preferably perpendicular, rail by said joining piece (45), in particular a corner piece.

18. The system as claimed in claim 17, characterized in that two adjacent rails (1′, 1″) nested in said joining piece (45) are connected by compensation means.

19. A method of plugging an opening, of the door opening or window opening type delimited by a door frame or window frame or of a type delimited by adjacent walls, including the following steps:
1) joining at least four structural sections two by two by means of a joining piece (45) to form a frame, each structural section forming a rail, said joining piece (45) having a first end (46) designed to be connected to a first rail (1′) and a second end (47) designed to be connected to a second rail (1″) adjacent said first rail,
2) placing the frame inside the opening so that it bears against each side of said opening,
3) inserting at least one substantially peripheral part of a plug element (27) in a groove present in each structural section or in a groove formed by the sliding of a second groove (7) of a second, internal structural section (1) in a first groove (20) of a first, external structural section (12) of a telescopic rail if said first and second structural sections are designed to co-operate by sliding, and
4) positioning at least one seal (29) in said groove (22) present on each structural section with a tight fit so as to fix thereto said at least one substantially peripheral part (27) of the plug element so as to form a system for plugging said opening,
characterized in that it includes a step before that of positioning said at least one seal (29) in which retaining means (34) having a first predetermined profile complementary to a second profile formed by said groove and internal lips defining its opening (35) are placed in said groove (22) between said substantially peripheral part (27) of a plug element and said seal (29), superposed on top of said at least one substantially peripheral part (27) of a plug element so as to retain it on said frame and so as to receive said seal (29) having a third predetermined profile designed to co-operate with said first predetermined profile of said retaining means (34).

20. The plugging method as claimed in claim 19, characterized in that it includes, before said step of joining at least four structural sections two by two to form the frame, a step of telescopic deployment of two structural sections designed to co-operate by sliding and forming a telescopic rail of said frame so that at least one joining piece (45) comes to abut against one of the corners of the opening, each rail being a telescopic rail including a first, external structural section (12) and a second, internal structural section (1), said first and second structural sections being designed to co-operate by sliding.

21. The plugging method as claimed in claim 20, characterized in that said step of telescopic deployment of each rail of said frame is followed by a plugging step in which said first, external structural section (12) is fixed temporarily in a predetermined position relative to said second, internal structural section (1).

22. The plugging method as claimed in claim 21, characterized in that said plugging step is followed by a step in which two adjacent rails of said frame are connected to one another by additional compensation means designed to exert a thrust on each rail so that they bear against the sides of the opening.

23. The plugging method as claimed in claim 19, characterized in that said step or positioning at least one seal (29) in said groove (22) of each structural section forming a rail is effected both in said groove (22) of a rail of said frame and in a longitudinal groove (48) present at said first end (47) of said joining piece (45), said groove (48) of said first end (47) of said joining piece (45) preferably being designed to receive retaining means (34).

24. The plugging method as claimed in claim 19, characterized in that said step of positioning at least one seal (29) in said groove (22) of each structural section forming a rail is effected both in said groove (22) of a structural section forming a rail of said frame and in a longitudinal groove (49) present at said second end (47) of said joining piece (45), said groove (22) of said second end (47) of said joining piece (45) being also designed to receive retaining means (34).

25. The method as claimed in claim 19, characterized in that it includes a step of inserting a front seal (454) with a tight fit in a front groove (453) disposed on a front flap (50) of at least one joining piece on top of a part of said plug element (27).
